(19) United States
(12) Patent Application Publication
(10) Pub. No.: US 2004/0239053 A1
(43) Pub. Date: Dec. 2, 2004

(54) Seal

(76) Inventors: Gordon D. Rowe, Wallingford, CT (US); Kenneth W. Cornett, Ivoryton, CT (US); D. Gregory More, Middletown, CT (US); Amitava Datta, East Greenwich, RI (US)

Correspondence Address: BACHMAN & LAPOINTE, P.C., 900 CHAPEL STREET, SUITE 1201, NEW HAVEN, CT, 06510, US

(21) Appl. No.: 10/890,473

(22) Filed: Jul. 12, 2004

Related U.S. Application Data
(63) Continuation-in-part of application No. 10/278,867, filed on Oct. 24, 2002, now abandoned.
(60) Provisional application No. 60/341,102, filed on Oct. 29, 2001.
(60) Provisional application No. 60/489,881, filed on Jul. 21, 2003.

(51) Int. Cl. F16L 21/02

(52) U.S. Cl. 277/650; 277/654

(57) ABSTRACT

In forming a bellows-like seal from a welded metallic band, improved mechanical properties may be obtained by welding the ends of a strip forming the band at an angle off-normal to the band rims (and seal axis). The angle may be a single angle (i.e., with a straight weld) or there may be multiple angles (e.g., with a serpentine or other convoluted weld). The weld may extend through the band normal to surfaces of the band or at an angle off-normal. The metallic band may comprise an oxide dispersion strengthened alloy.

### CROSS REFERENCE TO RELATED APPLICATION

This is a continuation-in-pat of U.S. patent application Ser. No. 10/278,867, filed Oct. 24, 2002 and entitled “High Temperature Seal” which claims benefit of U.S. patent application 60/341,102, filed Oct. 29, 2001 and entitled “High Temperature Seal” and benefit is claimed of U.S. patent application 60/489,881, filed Jul. 21, 2003 and entitled “Seal”. The disclosure of U.S. patent application Ser. Nos. 10/278,867, 60/341,102, and 60/489,881 are incorporated by reference in their entireties herein as if set forth at length.

### BACKGROUND OF THE INVENTION

This invention relates to seals, and more particularly to metallic seals.

A variety of metallic seal configurations exist. Key metallic seals are commonly held under compression between two opposed flanges of the elements being sealed to each other. Such metallic seals may be used in a variety of industrial applications.

Key examples of such metallic seals are of an annular configuration, having a convoluted radial section which permits the seal to act as a spring and maintain engagement with the flanges despite changes or variations in the flange separation. Certain such seals have an S-like section while others have a section similar to the Greek letter ε with diverging base and top portions. Other similar seals are formed with additional convolutions. One exemplary seal is sold by The Advanced Products Company, North Haven, Conn., as the E-RING seal. Such seals are commonly formed as a monolithic piece of stainless steel or superalloy. Such seals are commonly formed from sheet stock into a shape which is effective to provide the seal with a desired range of compressibility from a relaxed condition. These seals are installed in applications in a compressed state compressed between the mating flanges. The total compression (Δh_{T}) consists of an elastic component (Δh_{EL}) and plastic component (Δh_{PL}) so that Δh_{T}=Δh_{EL}+Δh_{PL}.

With continued exposure at elevated temperatures, the plastic component Δh_{PL} grows resulting from creep and the elastic component Δh_{EL} decreases with time. As a result, the sealing load or the capability of the seal to follow the flange movement also diminishes with time resulting from the reduced Δh_{EL}. This phenomenon is called stress relaxation.

Long-term applications of current metallic seals are generally limited to about 1300° F. (704° C.) because the current cold formable nickel-based superalloys such as INCONEL 718 (Special Metals Corporation, Huntington, W. Va.) and WASPALOY (Haynes International, Inc., Kokomo, Ind.), lose their strength at temperatures greater than 1300° F. (704°) and stress relax. At temperatures beyond about 1350° F. (732°), static seals under compression stress relax and a fraction of the compression strain converts permanently to plastic strain with exposure time. As a result, the sealing force, which is proportional to the elastic strain, diminishes with time thereby increasing leakage. Additionally, the seal loses its capability to follow the mating flanges if they retract to a position of greater separation (lesser compression).

The phenomenon of stress relaxation under constant strain stems from creep at elevated temperatures where the gamma prime precipitates in 718 and WASPALOY begin to coarsen, thereby increasing the rate of plastic (irreversible) flow. Hence, the temperature capability of static metallic seals could be enhanced if the gamma prime precipitate distribution is more stable well above 1350° F. (732°). Alternatively, the metallic alloys could be strengthened via solid solution hardening without any gamma prime precipitates or dispersion hardening where the particle dispersion imparting strength is stable at or above the application temperature.

There are other cast metallic alloys, such as MAR M247 (a cast superalloy used in manufacture of turbine engine blades available from Cannon-Muskegon Corporation of Muskegon, Mich., as CM 247) which are used at ultra high temperatures (about 2000° F. or 1100° C.) for thick cross section cast and wrought components. Difficulties have been encountered in attempts to roll these alloys into thinner gauges and cold form them into static seal shapes.

Recently developed oxide dispersion-strengthened (ODS) mechanically alloyed strips such as MA 754 of Special Metals Corporation of Huntington, W. Va. and PM 1000 of Plansee AG, Reutte, Austria, with superior high temperature strength characteristics are also very difficult to reliably fabricate into complex shapes (see, e.g., U.S. Pat. No. 5,815,791).

Some of the refractory alloy strips such as molybdenum base (e.g., titanium-zirconium-molybdenum (TZM)) and niobium base alloys, although cold formable, have poor oxidation resistance above 1200° F. (649° C.).

Therefore, there remains a need for a method of manufacturing a seal which can be used in demanding elevated temperature applications with enhanced stress relaxation resistance.

### SUMMARY OF THE INVENTION

In forming a bellows-like seal from a welded metallic band, improved mechanical properties may be obtained by welding the ends of a strip forming the band at an angle off-normal to the band rims (and seal axis). The angle may be a single angle (i.e., with a straight weld) or there may be multiple angles (e.g., with a serpentine or other convoluted weld). The weld may extend through the band normal to surfaces of the band or at an angle off-normal. Laser welding is a particularly advantageous technique and the method is believed particularly useful with oxide dispersion-strengthened alloys to control stresses associated with the weld during working of the band to form the final seal. The method may be used to form the band of a single layer seal or to form one or more of the bands of a multiple-layer seal.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a half longitudinal radial sectional view of a two-layer inwardly-facing E-seal.

FIG. 2 is a half longitudinal radial sectional view of a single layer outwardly-facing E-seal.

FIG. 3 is a half longitudinal radial sectional view of a single layer outwardly-facing U-seal.

FIG. 4 is a half longitudinal radial sectional view of a single layer outwardly-facing C-seal.

FIG. 5 is a longitudinal plan view of a seal-forming strip.

FIG. 6 is a longitudinal edge view of the strip of FIG. 5.

FIG. 7 is a view of a band formed from the strip of FIG. 5.

FIG. 8 is a view of a convoluted profile being rolled from the band of FIG. 7.

FIG. 9 is an edge view of the band of FIG. 7 showing strip ends before welding.

FIG. 10 is an edge view of the band of FIG. 7 showing strip ends after welding and before planishing.

FIG. 11 is a side view of a weld of a first alternate band.

FIG. 12 is a side view of a weld of a second alternate band.

FIG. 13 is a side view of a weld of a third alternate band.

Like reference numbers and designations in the various drawings indicate like elements.

### DETAILED DESCRIPTION

FIG. 1 shows a seal 20 formed as an annulus having symmetry about a central longitudinal axis 500. In operation, the seal is held in compression between opposed parallel facing surfaces 502 and 503 of first and second flanges 504 and 505 to isolate an interior volume 506 from an exterior volume 507.

The seal is formed as a convoluted sleeve having first and second layers 22 and 24 and extending from a first end 26 to a second end 28. In the exemplary embodiment, the first layer 22 is generally interior of the second layer 24 and has first and second surfaces 30 and 32, respectively. Similarly, the second layer 24 has first and second surfaces 40 and 42, respectively.

In one embodiment the result of this process is the production of a seal (e.g., seal 20) in which the layers (e.g., layers 22 and 24) are held together by macroscopic mechanical interfitting rather than adhesion at the microscopic level between the inner surface 40 of the layer 24 and the outer surface 32 of the layer 22. There may be a gap between the layers 22 and 24 or multiple gaps between the layers 22 and 24 (where the layers contact at one or more discrete annular regions). It may be possible that there is discrete microscopic bonding (e.g., spot welds or annular welds at particular locations), and may also be no microscopic bonding at all. A major portion of the outer surface 42 of the layer 24 constitutes the external surface of the seal in contact with the volume 507. Portions 44 and 46 of the surface 42 slightly recessed from the ends 26 and 28, face longitudinally outward and provide bearing surfaces for contacting the flange surfaces 502 and 503 to seal therewith. Each of the layers 22 and 24 preferably makes a substantial contribution to the longitudinal compression strength and performance of the seal 20. Preferably in an anticipated range of operation, each layer 22 and 24 contributes at least ten percent (10%) and, preferably, thirty percent (30%). As noted above, the contribution provided by each layer depends upon factors including, for example, the operating temperature.

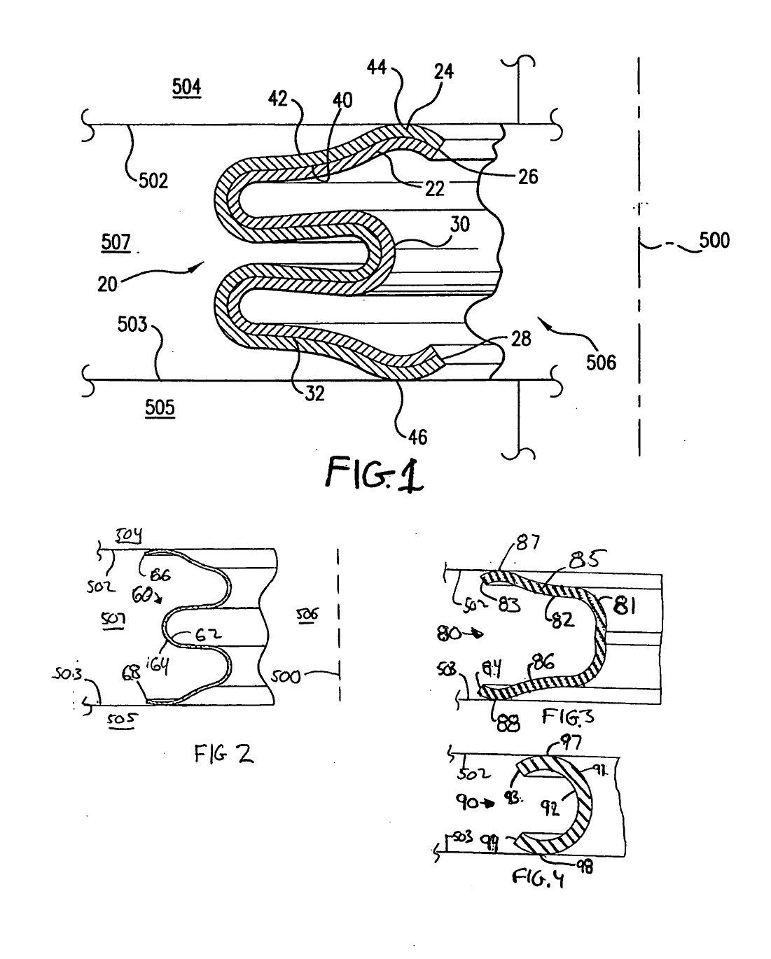

FIG. 2 shows an alternate seal 60 similarly isolating the interior volume 506 from the exterior volume 507. The seal cross-section reveals first and second surfaces 62 and 64 extending between first and second ends or rims 66 and 68. The exemplary seal 60 is an E-seal of opposite sense to the seal 20 (i.e., the convoluted cross-sectional shape faces in an opposite direction). Either variation is possible. There may be more or fewer convolutions. The seal may lack symmetry about a transverse centerplane (e.g., as in the case of an S-seal wherein one rim is directed into the interior volume 506 and the other rim is directed into the exterior volume 507). Yet further variations include radial seals (e.g., where the convoluted cross-section is rotated 90° relative to the face seals of FIGS. 1 and 2). FIG. 3 shows yet another alternate face seal 80 having first and second surfaces 81 and 82 and first and second rims 83 and 84. The exemplary seal 80 is an outwardly-open U-seal characterized by relatively straight portions 85 and 86 inboard of the bearing/sealing surface portions 87 and 88. FIG. 4 shows an alternate seal 90 having first and second surfaces 91 and 92 and first and second rims 93 and 94. The section of the seal 90 is formed as a continuously curving, arcuate, inflection-less section along which the bearing/sealing surface portions 97 and 98 are located.

According to the invention, a single layer seal or one or more layers of a multi-layer seal such as shown above may be manufactured from precursors initially formed as a flat strip of cold-formable material (i.e., it may be formed into a complex shape (e.g., having a radial section of bellows-like structure) at a temperature which is less than half its melting temperature and, preferably, at ambient conditions (e.g., room temperature)). The ends of the strip may be welded to form a sleeve or band, the two faces of the strip thereby becoming interior and exterior faces of the sleeve. In a multilayer configuration, the sleeves may be assembled concentrically and deformed into a convoluted shape.

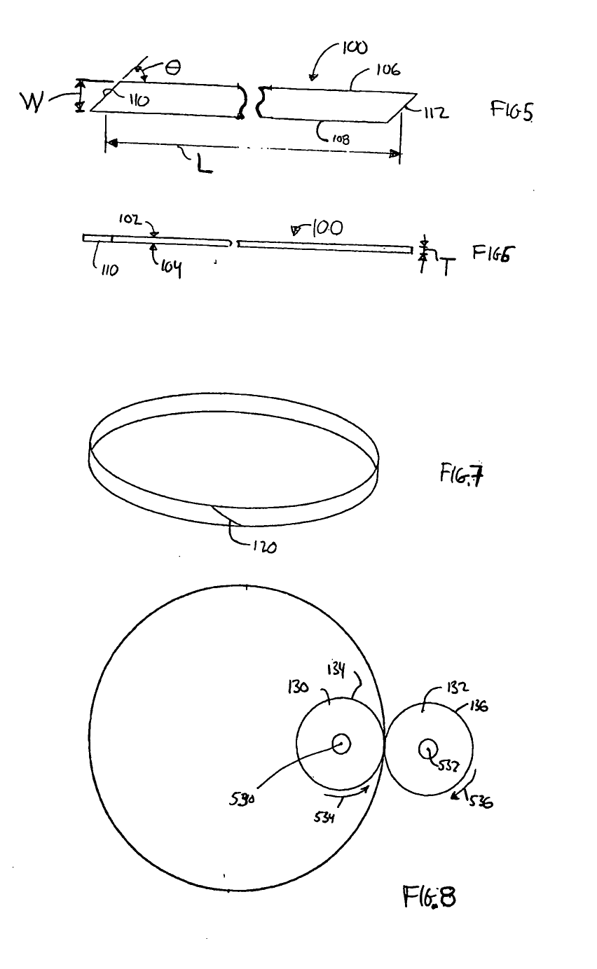

FIGS. 5 and 6 show a strip 100 which, itself, may be cut from a larger piece of material. The strip has first and second generally flat side surfaces 102 and 104 (FIG. 6) separated by a thickness T for respectively forming the principal surfaces of the seal layer. The surfaces 102 and 104 extend between edge surfaces 106 and 108 (FIG. 5) separated by a strip width W and which ultimately form the seal layer rim/edge surfaces. The strip further has first and second opposed longitudinal end surfaces 110 and 112 which are brought toward each other to form the sleeve (FIG. 7). FIG. 5 further shows the strip having a length L between characteristic (e.g., median) points along the end surfaces. Exemplary strip thickness T is less than 0.90 mm. Exemplary strip width W is between 2.5 mm and 65 mm (“between” being inclusive unless indicated as exclusive). Exemplary band diameter (i.e., L/π) is between 125 mm and 1.1 m. Other sizes are possible as are non-circular planforms

FIG. 5 shows the end surfaces as straight and at a non-perpendicular angle θ to the length of the strip and the edge surfaces. Viewed in an inward or outward, relative to the central longitudinal axis of the band or to a local central longitudinal radial plane (or, more generically to a plane locally perpendicular to the seal), the surfaces extend by the complement of θ. Advantageous θ may be between 20° and 70°, more narrowly, 40° and 60°, with an exemplary value of 45°. When the end portions are brought together as in FIG. 7, they may be welded at their junction 120 (e.g., of abutting surfaces 110 and 112). After welding, the sleeve may be subjected to a planishing process to flatten the weld. This may be achieved via use of a press (not shown) to apply pressure between the surfaces 102 and 104 proximate the weld to flatten the transition of those respective surfaces across the weld. After planishing, excess weld material protruding along the edge surfaces may be removed such as by belt sanding or other deburring. The sleeve (or assembled concentric sleeves in certain multi-layer seals) may then be run through a pair of rolling dies 130 and 132 rotating about their respective axes 530 and 532 in directions 534 and 536. Complementary convoluted perimeters 134 and 136 of the dies form the convoluted cross-section of the seal from the flat cross-section of the sleeve.

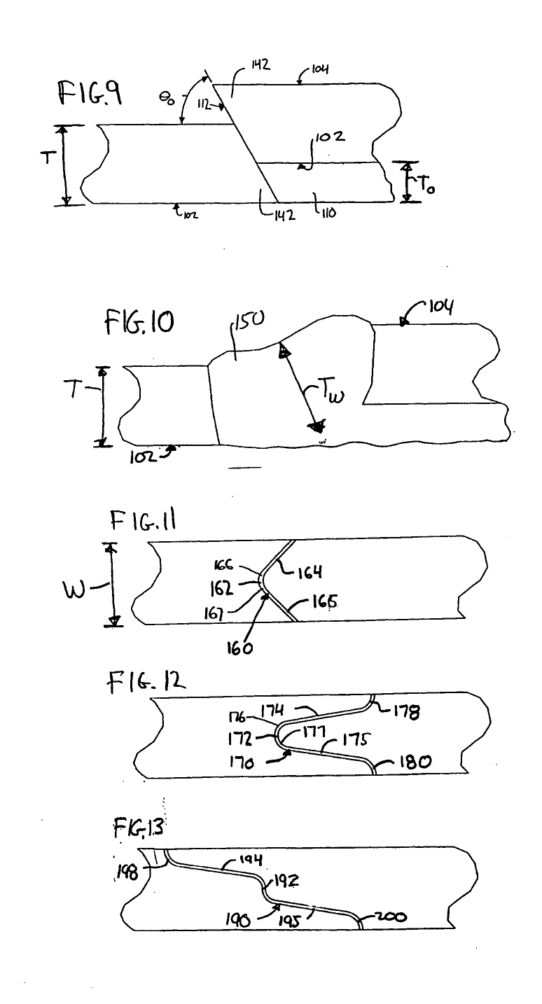

In a further variation, the end surfaces 110 and 112 may be at compound angles (i.e., also at a non-right angle θ₀ (FIG. 9) to the surfaces 102 and 104 and thus are perpendicular to those surfaces by the complement of θ₀. Simultaneously (as shown) or alternatively, when brought together for welding, the surfaces 110 and 112 may be offset so as to contact each other along less than their entire span between surfaces 102 and 104 thus creating a step or offset of thickness T₀. The combination of compound angle and offset serves to provide additional material for the weld from the protruding corner portions 140 and 142 of the strip ends. This additional material helps assure that, with shrinkage upon weld cooling and planishing (which, with the offset, serves to remove this step), the surfaces along the weld will not end up sub-flush to surfaces away from the weld. Advantageous T₀ are in excess of 10% and typically less than 60%, more narrowly between 20% and 40%. Advantageous θ₀ are between 30° and 80°, inclusive, more narrowly 50° and 70°. FIG. 10 shows the welded strip with a weld 150 prior to planishing. The weld has a local thickness T_{W} which is greater than T so as to avoid the sub-flush condition upon planishing.

The surfaces 110 and 112 may be other than single planar facets. FIGS. 10, 11 and 12 show welded sleeves formed from strips where the end surfaces have interfitting complementary convoluted profiles which define the weld profile. A particular weld profile may be selected in view of the ultimate convoluted cross-section of the seal so as to minimize stress at the weld or during manufacture and/or use. For example, the weld geometry will reflect a balance of several factors. First, to minimize stress in the weld during manufacture it may be best to bend the material perpendicular to the weld. Second, due to the brittleness of the weld, however, it may be undesirable to have the entire weld passing through the forming dies simultaneously. The cross-sectional profile of the seal is also relevant. For very tight radii of curvature, it may be advantageous for 0 to locally be very close to 90°. Where the radius of curvature is greater, concerns of a bending fracture are less than concerns of a tearing fracture. In such locations a low value of θ wherein the weld is not simultaneously passing through the dies may be more advantageous. For example, FIG. 11 shows a weld 160 having a central portion 162 and relatively straight lateral portions 164 and 165 extending toward the rims of the band. For the illustrated embodiment, exemplary θ for these portions is approximately 45°. θ increases to closer to 90° over respective inboard transitions 166 and 167 near the central portion 162. Such a profile may be useful with a seal having a relatively tight radius of curvature at its transverse centerplane and greater radius of curvature outboard thereof. FIG. 12 shows a band having a weld 170 with a central portion 172. Relatively straight low θ portions 174 and 175 (e.g., less than 30°) are separated from the central portion by transition portions 176 and 177 where θ increases. Outboard of the portions 174 and 175, further transition portions 178 and 180 also transition to a very high θ (e.g., near 90°). Such a weld profile could be associated with a seal having a relatively small radius of curvature near its transverse centerplane and relatively small radii of curvature at its outboard extremes with higher radii of curvature portions therebetween. FIG. 13 shows a weld 190 which, for purposes of illustration, has identical shape on either side of the transverse centerplane to that of the weld 170, with a central portion 192, low θ portions 194 and 195 and higher θ outboard transition portions 198 and 200. The weld 190, however, lacks the reflective symmetry about the transverse centerplane and, instead, has an opposite symmetry.

Key strip materials are dispersion hardened alloys which may present particular problems with conventional weld techniques. These alloys are hardened by very stable oxide particles whose dispersion distribution is stable well above 1350° F. (732° C.). Such metallic alloys, called oxide dispersion strengthened (ODS) alloys, are commonly Ni- or Fe-based. The use of ODS alloys in seals is disclosed in U.S. patent application Ser. No. 10/278,867 and such seals may be manufactured using the methods disclosed herein. Exemplary alloys are produced by Plansee AG of Reutte, Austria as PM 1000 (nominal chemical composition in weight %: 20 Cr, 3 Fe, 0.5 Ti, 0.3 Al, 0.6 Y₂O₃, remainder Ni), PM 2000 (nominal chemical composition in weight %: 20 Cr, 5.5 Al, 0.5 Ti, 0.3 Al, 0.5 Y₂O₃, remainder Fe), and PM 3030 (nominal chemical composition weight %: 17 Cr, 6 Al, 3.5 W, 2.0 Mo, 2.0 Ta, 0.15 Zr, 0.9 Y₂O₃, remainder Ni) and by Special Metals Corp. of Huntington, W. Va. as MA 754 ((UNS N07754) nominal chemical composition in weight %: 20Cr, 1.0Fe, 0.05C, 0.3Al, 0.5Ti, 0.6 Y₂O₃ remainder Ni) and MA 956 ((UNS S67956) nominal chemical composition, in weight %: 20Cr, 4.5Al, 0.5Ti, 0.05C, 0.5 Y₂O₃, remainder Ni) and MA 758 (nominal chemical composition in weight %: 30 Cr, 1.0 Fe, 0.3 Al, 0.5 Ti, 0.05C, 0.6 Y₂O₃, remainder Ni). Generically, exemplary nickel-based ODS alloys may have compositions in weight % of 15-35 Cr, 0.1-10 Al, 0.3-2 Y₂O₃, 0-5 Fe, 0-1 Ti, 0-5 W, 0-5 Mo, 0-5 Ta, 0-1 Zr, 0-1 C, plus impurities. Exemplary iron-based ODS alloys have such compositions of 15-25 Cr, 0.1-10 Al, 0.3-2 Y₂O₃, 0-5 Ni, 0-1 Ti, 0-5 W, 0-5 Mo, 0-1 Zr, 0-1 C, 0-1 Cu, 0-1 Mn, 0-1 P, 0-1 Co, plus impurities.

It is believed that the particular welding problems involved with ODS alloys result from the formation of large voids during the welding. The weld itself is a solidified weld pool. However, there will be an adjacent heat affected zone (HAZ) in which material properties are altered relative to the original material. In particular, a brittle region forms in the pool at the transition between the pool and the HAZ. Small voids in the base material associated with the inherent porosity involved in the powder metallurgical fabrication of the base material may merge into larger voids in the transition and HAZ during the weld process. With rapid cooling, the voids in the transition may become trapped before they can gas out of the weld. The voids act like perforations and may make this transition region brittle and particularly prone to fracture upon working. With the angled weld, during the working stresses are relieved by being transferred across the weld as opposed to parallel to the weld and the interface with the HAZ.

The particular use of laser welding is believed advantageous in that the laser is believed to create small circular weld pools so that the voids at the transitions form more of a zigzag pattern then a straight pattern. The zigzag pattern is believed to better handle increased stresses. Exemplary thermal operating conditions for the seal are in the range of about 1500-2000° F. (about 816-1093° C.) or even more. A more narrow target is about 1600-1800° F. (about 871-1038° C.). It should be appreciated that this does not necessarily mean that the seal can not be used under more conventional conditions.

For single layer seals or essentially single layer seals (e.g., seals wherein a single layer has one or more structurally less significant coating layers) particularly advantageous materials may be Ni-based ODS alloys. In multi-layer seals, the ODS alloy (and thus Ni-based alloys, in particular) may advantageously provide the principal compressive strength and act as the principal energizing spring element. Advantageously the second or other layer would be the layer that contacts the flanges. Exemplary second layer material may advantageously be more ductile and formable and more subject to stress relaxation than the first layer material (which is less ductile and stronger at the target operating conditions) so as to define a good sealing footprint. Exemplary second layer materials include non-ODS Ni-based superalloys and Fe-based ODS superalloys.

One or more embodiments of the present invention have been described. Nevertheless, it will be understood that various modifications may be made without departing from the spirit and scope of the invention. For example, the seals may have various existing or other convoluted cross-sections and planform shapes. Accordingly, other embodiments are within the scope of the following claims.

What is claimed is:

1. A method of manufacturing a seal, comprising:
forming an open hoop of material having first and second end surfaces having respective first and second portions facing each other and extending off-parallel to a central longitudinal axis of the seal;
welding the first and second portions to each other to form a closed hoop; and
deforming the closed hoop to create a convoluted cross-section.

2. The method of claim 1 wherein:
the first and second end surfaces respectively consist essentially of said first and second portions.

3. The method of claim 1 wherein:
the first and second portions are first and second flat facets.

4. The method of claim 1 wherein:
the first and second end surfaces comprise, in major part, complementary interfitting shapes.

5. The method of claim 1 wherein:
the open hoop comprises, in major part, a Ni- or Fe-based oxide dispersion-strengthened alloy.

6. The method of claim 1 wherein:
said welding comprises laser welding.

7. The method of claim 6 wherein:
said laser welding is performed in the absence of a separate filler material.

8. The method of claim 1 wherein:
the forming forms said first and second portions extending at least 20° off parallel to said central axis.

9. The method of claim 1 wherein:
the forming forms said first and second portions extending 40°-50° off parallel to said central axis.

10. The method of claim 1 wherein:
the forming further forms said first and second portions extending at least 10° off perpendicular to inboard and outboard surfaces of the open hoop.

11. The method of claim 1 wherein the forming comprises:
cutting the material from a strip and bending said cut material into the open hoop

12. The method of claim 1 further comprising:
planishing the closed hoop.

13. The method of claim 1 further comprising:
during the welding, holding the first and second portions with a thickness offset of at least 10% of a local thickness of the open hoop.

14. The method of claim 13 wherein:
the thickness offset is 10-60% of said local thickness.

15. The method of claim 1 wherein the deforming forms the convoluted cross-section in one of a U, C, S, and E.

16. The method of claim 1 wherein the deforming forms the convoluted cross-section to form one of a face seal and a radial seal.

17. The method of claim 1 wherein the closed hoop is a first closed hoop and the method further comprises assembling the first closed hoop concentrically with a second closed hoop prior to the deforming.

18. A seal for forming a seal between interior and exterior volumes when held under compression between opposed first and second faces of respective first and second flanges, the seal and having at least one weld at least partially extending off-parallel to a plane locally perpendicular to the seal.

19. The seal of claim 18 wherein:
the seal comprises an oxide dispersion strengthened metallic alloy.

20. The seal of claim 19 wherein the alloy comprises in weight %:
15.0-35.0% Cr;
0.1-10.0% Al; and
0.3-2.0% Y₂O₃.

21. The seal of claim 19 wherein the alloy further comprises:
0.1-1.0% Ti.

22. The seal of claim 18 wherein the weld at least partially extends at least 20° off-parallel to said plane.

23. The seal of claim 18 wherein the weld is in a first layer and the seal comprises a second layer.

24. The seal of claim 23 wherein:
the first layer consists essentially of an oxide dispersion strengthened metallic alloy; and
the second layer consists essentially of material selected from the group consisting of:
solid solution hardened metallic alloy; and
age hardening nickel-base superalloy.

25. An annular seal having a central longitudinal axis and forming a seal between interior and exterior volumes when held under compression between opposed first and second faces of respective first and second flanges, the seal comprising an oxide dispersion strengthened metallic alloy.

26. The seal of claim 25 having at least one weld at least partially extending off-parallel to a plane locally perpendicular to the seal.
